(19) United States
(12) Patent Application Publication
(10) Pub. No.: US 2003/0197723 A1
(43) Pub. Date: Oct. 23, 2003

(54) Methods, apparatus and computer program products for providing network device status information

(76) Inventors: Brian R. Young, Raleigh, NC (US); Jim Thompson, Raleigh, NC (US)

Correspondence Address: MYERS BIGEL SIBLEY & SAJOVEC, PO BOX 37428, RALEIGH, NC, 27627, US

(21) Appl. No.: 10/278,064

(22) Filed: Oct. 22, 2002

Related U.S. Application Data
(60) Provisional application No. 60/373,900, filed on Apr. 19, 2002.

(51) Int. Cl. G09G 5/00

(52) U.S. Cl. 345/738

(57) ABSTRACT

Status information for a network device, such as an uninterruptible power supply (UPS), may be provided by displaying a web browser window uniquely associated with the network device and having a color indicative of a status of the network device. In particular, a field of the web browser, such as a background field, may be color coded responsive to a status of the network device. According to further aspects of the invention, a plurality of web browser windows may be concurrently displayed on the same display screen. The plurality of web browser windows have visual appearances that convey respective statuses of respective ones of the network devices according to a common visual coding scheme, such as a color coding or image coding scheme.

### RELATED APPLICATION

This application claims priority from U.S. Provisional Application Serial No. 60/373,900, entitled “NETWORK DEVICE MONITORING USING COLOR-CODED STATUS WEB PAGES,” filed Apr. 19, 2002, the disclosure of which is incorporated herein by reference in its entirety.

### FIELD OF THE INVENTION

This invention relates to computer systems, methods and computer program products, and more particularly to graphical computer systems, methods and computer program products.

### BACKGROUND OF THE INVENTION

There are a variety of conventional techniques for monitoring networked devices, such as servers, routers, printers, uninterruptible power supplies (UPSs) and the like. For example, there are a number of network management programs that display a network topology in some representational format, such as a plurality of icons that represent devices and which are connected by lines or other graphic elements that indicate network connectivity. Some network management applications may show status of individual devices and/or interconnections by applying color codes to the icons and/or the connecting graphic elements. Other conventional techniques provide status information in tabular or chart form. Potential drawbacks of such approaches may include software overhead and complexity associated with creating and maintaining a complex graphical representation of a network, and the difficulty of discerning the status of objects in a graphical network diagram or table for a network that includes a large number of devices and interconnections.

### SUMMARY OF THE INVENTION

In some embodiments of the invention, status information for a network device, such as an uninterruptible power supply (UPS), may be provided by displaying a web browser window uniquely associated with the network device and having a color indicative of a status of the network device. In particular, a field of the web browser, such as a background field, may be color coded responsive to a status of the network device.

According to further aspects of the invention, an apparatus may host such a web page. In some embodiments, the page is hosted at the network device itself. In response to a broadcast query message transmitted by a monitoring apparatus, such as a computer, the hosting apparatus may receive the broadcast message and responsively transmit a message identifying the address of the hosted web page. The hosting apparatus may also host a second web page providing textual status information for the network device and accessible from a link in the first web page.

In further embodiments of the invention, a plurality of web browser windows are concurrently displayed on the same display screen. The plurality of web browser windows have visual appearances that convey respective statuses of respective ones of the network devices according to a common visual coding scheme, such as a color coding or image coding scheme.

Embodiments of the invention can provide advantages over network representations and other forms commonly used in network monitoring applications. For example, in some embodiments, providing respective color-coded browser windows for respective ones of a plurality of network devices can allow status changes to be quickly detected without requiring detailed scrutiny of network diagrams, tables or other complex representational formats. The web pages that are used to generate the web browser windows can be stored at the monitored devices themselves. According to further embodiments, using visually coded web browser status windows can provide a relatively simple mechanism for navigation to detailed textual status information. The invention may be embodied as methods, apparatus, and computer program products.

### BRIEF DESCRIPTION OF THE DRAWINGS

FIG. 1 is a schematic diagram illustrating apparatus for hosting and monitoring color coded status web pages according to some embodiments of the invention.

FIG. 2 is a screen shot of a colored status web browser window according to some embodiments of the invention.

FIG. 3 is a screen shot of a detailed status web page linked to a color status web page according to further embodiments of the invention.

FIG. 4 is a schematic diagram illustrating apparatus and operations for hosting and monitoring color coded status web pages according to further embodiments of the invention.

FIG. 5 is a screen shot of a plurality of colored status windows according to additional embodiments of the invention.

FIG. 6 is a flow chart illustrating exemplary operations for identifying and accessing color coded status web pages according to additional embodiments of the invention.

### DETAILED DESCRIPTION

The present invention will now be described more fully with reference to the accompanying drawings, in which typical embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Various embodiments of the invention involve providing status information for a network device, which may include, but it is not limited to, devices such as networked printers, computers, scanners, uninterruptible power supplies (UPSs) and the like. The invention may be advantageously practiced using computers, e.g., personal computers, laptop computers, notebook computers, computer workstations, personal digital assistants (PDAs), and other devices, connected by a network, such as the Internet. The Internet is a worldwide decentralized network of computers having the ability to communicate with each other. The Internet has gained broad recognition as a viable medium for communicating and for conducting business. The World-Wide Web (Web) was created in the early 1990's, and is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. A Web server (also referred to as an HTTP server) is a computer program that generally utilizes HTTP to serve files that form Web pages to requesting Web clients. Exemplary Web servers include International Business Machines Corporation's family of Lotus Domino® servers, the Apache server (available from www.apache.org), and Microsoft's Internet Information Server (IIS), available from Microsoft Corporation, Redmond, Wash. A Web client is a requesting program that also generally utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized with the present invention include, but are not limited to, Netscape Navigator® and Internet Explorer™. Browsers typically provide a graphical user interface for retrieving and viewing Web pages, applications, and other resources served by Web servers.

It will be appreciated that the invention can be implemented using any of a number of different types of network configurations. It will be further appreciated that the invention may, in general, be implemented using a variety of different communications technologies, including wireline, optical and wireless communications technologies. The invention may be embodied as methods, apparatus and/or computer program products. The invention may take the form of an entirely hardware embodiment or an embodiment combining software and hardware aspects. Furthermore, the present invention may take the form of a computer program product on a computer-usable storage medium having computer-usable program code embodied in the medium. Any suitable computer readable medium may be utilized, including, but not limited to, hard disks, CD-ROMs, optical storage devices, or magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, JavaScript, Visual Basic, TSQL, Perl, or in a functional (or fourth generation) programming language such as Lisp, SML, or Forth. The program code may execute entirely on one computer, or may be executed in part on each of a plurality of computers. A variety of different conventional software tools may be used in creating web browser windows representations as described herein, such as Netscape Navigator and Internet Explorer.

According to some embodiments of the invention, in an environment where multiple web-enabled devices, such as uninterruptible power supplies (UPSs) or similar networked devices or network “appliances,” are being monitored via the internet, a device may support a web page that produces a browser window with a color background representing the status of the network device. Software can be utilized to display multiple such “windows” for a plurality of networked devices, e.g., by tiling, cascading or otherwise displaying the plurality of windows on a computer screen. As the color of a window background or other prominent window display field or feature may be used to display status, status of each device can be made more plainly visible in a relatively simple fashion. The colored status windows may further be navigable to more detailed status and/or control pages.

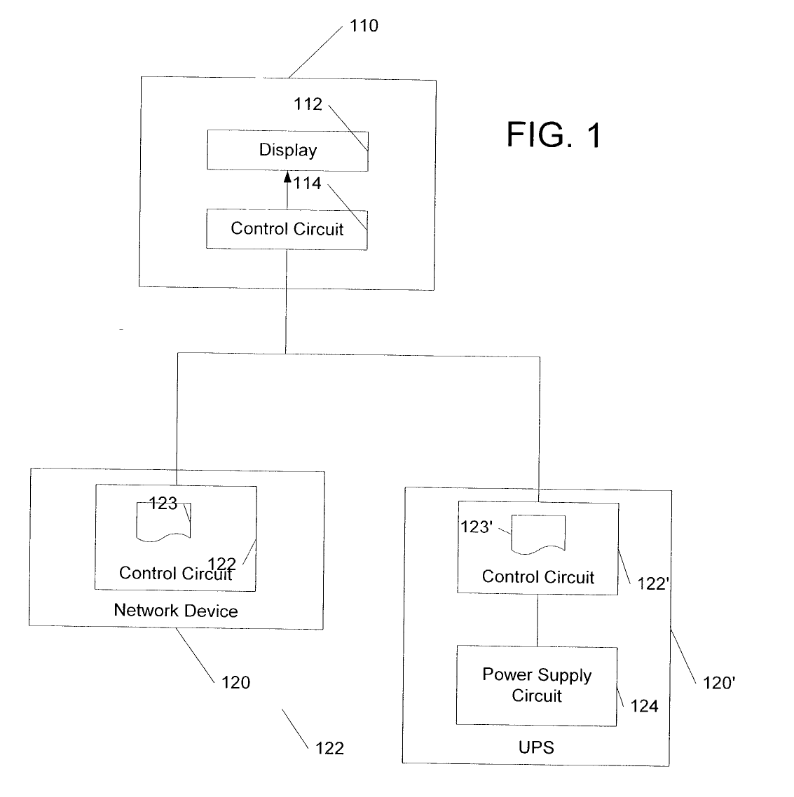

FIG. 1 illustrates an apparatus 110 for monitoring network devices 120, 120′ illustrated in FIG. 1. The apparatus 110 includes a display 112 and a control circuit 114 that is operative to control the display 112 and to communicate with the network devices 122, 122′. For example, the apparatus 110 may take the form of a desktop computer, laptop, personal digital assistant, wireless terminal, or the like. The display 112 may comprise, for example, a cathode ray tube (CRT), liquid crystal display (LCD), plasma display or the like, and the control circuit may comprise a microprocessor, microcontroller or similar processing device and associate peripheral circuitry, including memory and communications interface circuitry.

Each network device 120, 120′ includes a respective control circuit 122, 122′, such as a network interface card or functionally equivalent circuitry, that acts as a host or server for a web page 123, 123′ that is color coded according to a status of the networked device 120, 120′. The control circuits 122, 122′ may provide other functionality, such as monitoring and/or control of other circuitry in the network devices 120, 120′ via the network. For example, as shown in FIG. 1, a network device 120′ may be an uninterruptible power supply (UPS) that includes power supply circuitry 124 that is controlled and/or monitored using the control circuit 122′. The control circuit 114 of the apparatus 110 is operative to access, e.g., retrieve, the hosted web pages 123, 123′ and to provide a display of the accessed web pages in a browser window on the display 112.

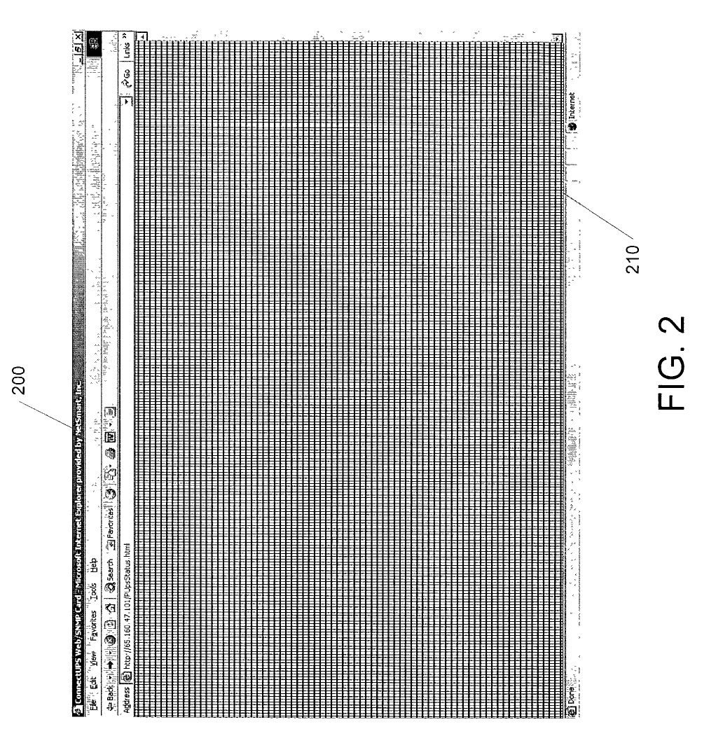

For example, a network card, such as a ConnectUPS SNMP/WEB card produced by Powerware Corporation that provides network connectivity for a UPS, may include software and/or firmware that supports a web page that, when pointed at by a web browser, such as Netscape Navigator or Microsoft Internet Explorer, provides a visual web page representation 200 having a display field or feature, e.g., a background field 210, colored to indicate various states of the UPS being monitored, as illustrated in FIG. 2. For example, 4 colors may be assigned as follows:

Green There is communication with the UPS and everything is normal

Yellow There is communication with the UPS and there is some sort of alarm or change in status (other than a low battery condition)

Red There is communication with the UPS and there is a Low Battery condition

Black Communication has been interrupted between the ConnectUPS SNMP/WEB card and the UPS

It will be appreciated that, aside from the color coding described above, provision of distinctive status display in respective browser windows may be provided in other ways within the scope of the invention. For example, referring to the example of FIG. 2, all of the background field 210 need not be uniformly colored as in FIG. 2. Text or other graphic content may be superimposed on the background field 210. In some embodiments, a distinctive display may include graphic elements (e.g., caricatures, icons, or the like) with colorings or other graphic features that distinctively correlate to states of a device. For example, a predominantly red graphic may be used to represent a failure condition, a predominantly green graphic may be used to represent a normal condition, etc. In monochromatic applications, different grey scale values could be used. In further embodiments, different distinctive graphic elements may be used to represent different status conditions in lieu of using a color code.

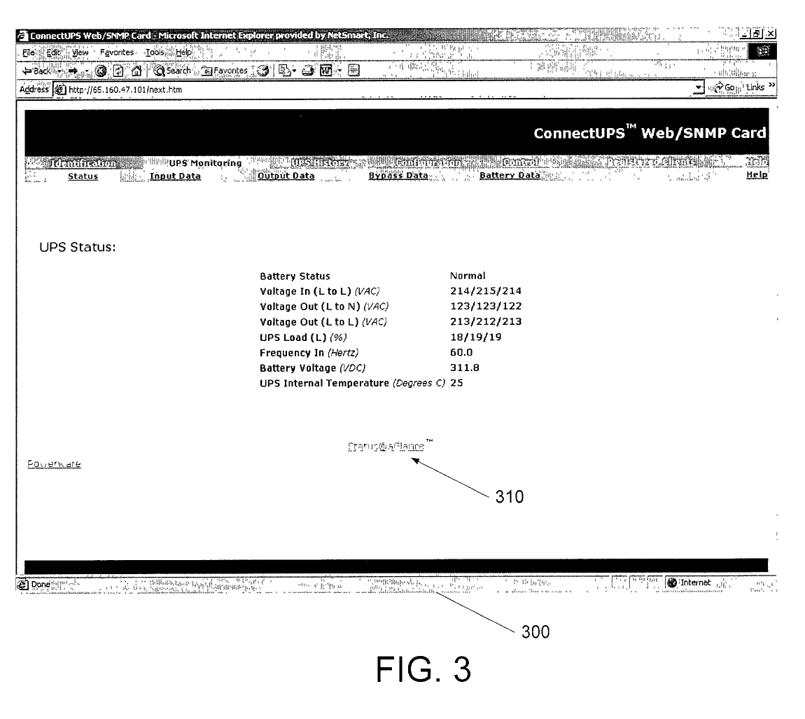

According to further embodiments of the invention, other status-related web pages can be linked to such a status web page. For example, as shown in FIG. 3, a detailed status page 300 supported by the ConnectUPS SNMP/WEB card may include a text link 310 that a user can “click” on to take them to the color status page. According to still further embodiments of the present invention, navigation from the color-coded status page, such as that illustrated in FIG. 2, to, for example, a detailed status page, such as the page illustrated in FIG. 3, may be achieved by clicking on the colored space within the window.

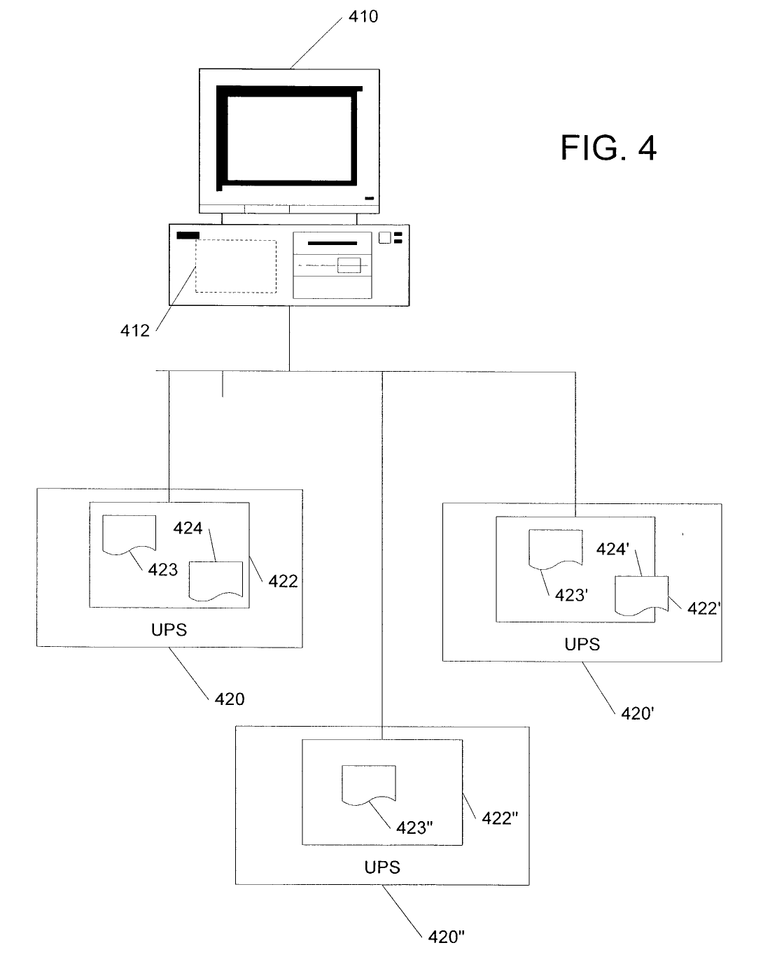

According to additional aspects of the invention, a plurality of status web pages, respective ones of which are associated with respective network devices being monitored and which are visually coded according to a common visual coding scheme, such as a color code, image set, or the like, are concurrently displayed. For example, referring to FIG. 4, UPSs 420, 420′, 420″ may have respective ones of ConnectUPS SNMP/WEB cards 422, 422′, 422″ installed therein, each supporting a status monitor web page 423, 423′, 423″ as described above.

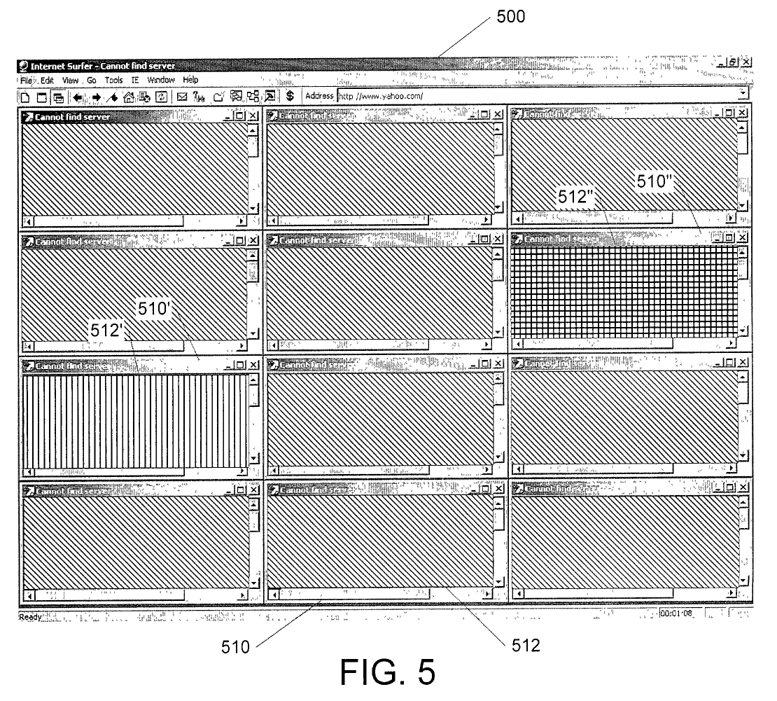

Some of the UPSs 420, 420′ may further host textual status web pages 424, 424′ that are linked to the status web pages 423, 423′. The status pages 423, 423′ may serve, for example, as “home pages” for the UPSs 420, 420′. A personal computer 410 (or other terminal, workstation or the like) may be networked with the UPSs 420, 420′, 420″ and may include an application program 412 capable of spawning a plurality of web browser windows therein, respective ones of which are pointed to respective ones of the web pages of the network cards. For example, as shown in FIG. 5, corresponding windows 510, 510′, 510″ may include color coded background fields 512, 512′, 512″, and may be tiled within a window 500 displayed on the computer, for example, in rows and columns (other arrangements could be used). Such a tiled displayed of embedded web browser windows may be generated using, for example, Internet Surfer software available as shareware at www.jackflacco.com.

Such a display can allow a user to quickly determine access at a glance, without, for example, searching through complex network representations to find particular devices. In particular, in embodiments using color coding of a background field of browser windows, a user may be able to quickly determine the status of all the UPSs, as the use of background coloring or other distinctive graphics can make it easy to detect states that indicate a need for further investigation. For example, in the exemplary implementation illustrated in FIG. 5, if 12 UPSs are working properly, a field of 12 green windows could be displayed. Failure of one or more of these could be quickly detected, as a red, yellow or black window could be quickly detected. It will be appreciated that similar advantages may be provided within the scope of the invention may be provided by using a visual coding other than color, for example, by using respective images of a set of predetermined images to represent respective status conditions.

According to still further embodiments of the present invention, a utility may be provided that discovers network devices that support such status monitoring, such as the ConnectUPS SNMP/WEB cards described above, and that responsively creates a monitoring display comprising a plurality of displayed color web pages. For example, software for a personal computer or other network terminal may be configured to search web addresses associated with UPSs and/or other devices, to determine if these addresses support status monitoring as described above, and then spawn appropriate browser windows to provide user monitoring of such devices. Such software could, for example, tile or cascade such windows on the terminal screen automatically.

For example, for a UPS application as described above, a configuration utility of a UPS monitoring/control program may be able to discover existing ConnectUPS SNMP/WEB Cards on the network and allow a user to select those cards (or all cards) to be elected as windows within a display space, e.g., browser window, generated by the application. Cards that already have windows displayed (e.g., as indicated by a database or registry) can be indicated as such to prevent duplicate windows, unless the user wishes duplicate display. The configuration program may also modify the application's Uniform Resource Locator (URL) database such that the next time the status/control program starts, the new windows will be displayed. If some cards have been removed from the network in the intervening time, windows corresponding to the removed cards can be deleted from the configuration database.

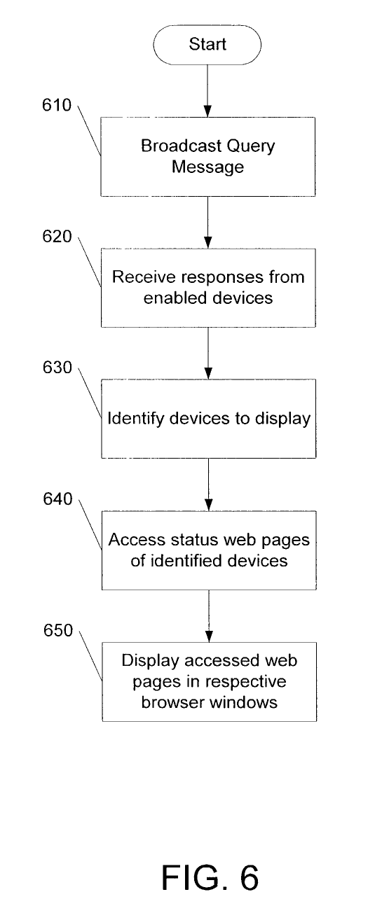

FIG. 6 illustrates exemplary operations according to some embodiments of the invention. A query message is broadcast on a network containing a plurality of network devices (Block 610). For example, such a query message may be transmitted by an application program executing on network-connected workstation and may express the query by, for example, using a port address addressed to a port having a predetermined association with the status monitoring web page functionality. Devices that support the functionality may receive and recognize the query message, and respond by sending messages that identify their network locations, e.g., IP addresses (Blocks 620, 630). The application program may then selectively access the identified web pages and display the accessed web pages in respective browser windows (Blocks 640, 650). For example, the application program may display a pop-up window that may be used to select devices for which a status display window is desired, such that the application program responsively displays the status web pages of the selected devices.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of providing status information for a network device, the method comprising:
displaying a web browser window uniquely associated with the network device and having a color indicative of a status of the network device.

2. A method according to claim 1, wherein displaying a web browser window uniquely associated with a network device and having a color indicative of a status of the network device comprises color coding a field of the web browser window responsive to a status of the network device.

3. A method according to claim 2, wherein the field comprises a background field.

4. A method according to claim 1, wherein the network device comprises an uninterruptible power supply (UPS).

5. A method according to claim 1, wherein displaying a web browser window uniquely associated with a network device and having a color indicative of a status of the network device comprises concurrently displaying a plurality of web browser windows uniquely associated with respective ones of a plurality of network devices and having respective colors indicative of respective statuses of the respective network devices on a single computer display screen.

6. A method according to claim 5, wherein concurrently displaying a plurality of web browser windows uniquely associated with respective ones of a plurality of network devices and having respective colors indicative of respective statuses of the respective network devices on a single computer display screen comprises embedding a plurality of web browser objects in a web browser object to generate the plurality of displayed web browser windows.

7. A method according to claim 5, wherein displaying a plurality of web browser windows is preceded by determining addresses of web pages associated with the network devices.

8. A method according to claim 7, wherein determining addresses of web pages associated with the network devices comprises:
broadcasting a query message on a network connecting the plurality of devices; and
receiving response messages identifying the addresses of the web pages.

9. A method according to claim 1, further comprising providing a link to a textual status web page in the displayed web browser page.

10. A method of providing status information for a network device, the method comprising:
hosting a web page that is operative to generate a web browser window unique to the network device and color coded according to a status of the network device.

11. A method according to claim 10, wherein hosting a web page comprises hosting the web page at the network device.

12. A method according to claim 10, wherein the network device comprises an uninterruptible power supply (UPS).

13. A method according to claim 10, wherein hosting a web page comprises hosting a web page operative to generate a web browser window having a field color coded according to a status of the network device.

14. A method according to claim 13, wherein the field comprises a background field.

15. A method according to claim 10, further comprising:
receiving a broadcast message requesting an address of the host web page; and
responsively transmitting a message identifying the address of the hosted web page.

16. A method according to claim 10, wherein hosting a web page comprises hosting a first web page, and wherein the method further comprises hosting a second web page providing textual status information for the network device and accessible from a link in the first web page.

17. A method of providing status information for a plurality of network devices, the method comprising:
concurrently displaying a plurality of web browser windows on the same display screen, the plurality of web browser windows having visual appearances that convey respective statuses of respective ones of the network devices according to a common visual coding scheme.

18. A method according to claim 17, wherein the common visual coding scheme comprises a color coding of the same display field in each of the web browser windows.

19. A method of providing device status information for a plurality of interconnected network devices, the method comprising:
hosting respective web pages at respective ones of the plurality of network devices, the web pages uniquely associated with the respective network devices and having visual appearances that convey statuses of the respective network devices according to a common visual coding scheme.

20. A method according to claim 19, wherein the common visual coding scheme comprises a color coding of the same display field in each of the web browser windows.

21. An apparatus, comprising:
a display screen; and
means for displaying a web browser window uniquely associated with a network device and having a color indicative of a status of the network device.

22. An apparatus according to claim 21, wherein the means for displaying a web browser window comprises means for color coding a field of the web browser window responsive to a status of the network device.

23. An apparatus according to claim 22, wherein the field comprises a background field.

24. An apparatus according to claim 21, wherein the network device comprises an uninterruptible power supply (UPS).

25. An apparatus comprising:
a display; and
a control circuit operative to access web pages and to control the display responsively thereto, the control circuit configured to determine a network address of a web page that, when accessed by the control circuit, produces a web browser window display uniquely associated with the network device and color coded according to a status of the network device.

26. An apparatus according to claim 25, wherein the control circuit is operative to locate respective web pages associated with respective ones of a plurality of network devices and to concurrently display a plurality of web browser windows uniquely associated with respective ones of the plurality of network devices and having respective colors indicative of respective statuses of the respective network devices on the display.

27. An apparatus according to claim 26, wherein the control circuit is operative to broadcast a query message on the network and to receive response messages identifying the addresses of the web pages.

28. An uninterruptible power supply (UPS) apparatus, comprising:
an uninterruptible power supply circuit; and
a control circuit operative to control the uninterruptible power supply circuit and to communicate over a communications network, wherein the control circuit hosts a web page configured to generate a web browser window unique to the UPS system and color coded according to a status of the UPS system.

29. An apparatus according to claim 28, wherein the web page is operative to generate a web browser window having a field color coded according to a status of the UPS system.

30. An apparatus according to claim 29, wherein the field comprises a background field.

31. An apparatus according to claim 28, wherein the control circuit is further operative to receive a broadcast message requesting an address of the web page and to responsively transmitting a message identifying the address of the web page.

32. An apparatus according to claim 28, wherein the web page comprises a first web page and wherein the control circuit is further hosts a second web page that provides textual status information for the UPS system and that is accessible from a link in the first web page.

33. A computer program product for providing status information for a network device, the computer program product comprising program code embodied in a computer-readable storage medium, the computer program code comprising:
program code configured to generating a web browser window uniquely associated with a network device and having a color indicative of a status of the network device.

34. A computer program product according to claim 33, wherein the program code configured to generating a web browser window comprises a web page configured to be stored at the network device.

35. A computer program product according to claim 33, wherein the program code configured to generating a web browser window comprises:
program code configured to detecting a network location of a web page that is operative to generate the web browser window;
program code configured to retrieving the web page from the detected network location; and
program code configured to displaying the retrieved web page.

36. A computer program product according to claim 33, wherein the program code configured to generative a web browser window comprises program code configured to generating a web browser window having a field color coded according to a status of the network device.

37. A computer program product according to claim 36, wherein the field comprises a background field.

38. A computer program product for providing status information for a plurality of network devices, the computer program product comprising program code embodied in a computer-readable storage medium, the computer program code comprising:
program code configured to concurrently generate a plurality of web browser windows on the same display screen, the plurality of web browser windows having visual appearances that convey respective statuses of respective ones of the network devices according to a common visual coding scheme.

39. A computer program product according to claim 38, wherein the common visual coding scheme comprises a color coding of the same display field in each of the web browser windows.

40. A computer program product according to claim 38, wherein the program code configured to concurrently generate a plurality of web browser windows on the same display screen comprises a plurality of web pages stored at the network devices.

41. A computer program product according to claim 38, wherein the program code configured to concurrently generate a plurality of web browser windows on the same display screen comprises:
program code configured to detect network locations of a plurality of web pages that are operative to generate the web browser window;
program code configured to retrieve the web pages from the detected network locations; and
program code configured to displaying the retrieved web pages.
